(19) United States
(12) Patent Application Publication
(10) Pub. No.: US 2008/0201161 A1
(43) Pub. Date: Aug. 21, 2008

(54) System and method for assessing condition and assigning value to watercraft

(76) Inventors: Patricia L. Kearns, Naples, FL (US); Christian L. Rogers, Centerville, MD (US)

Correspondence Address: MCDERMOTT WILL & EMERY LLP, 600 13TH STREET, N.W., WASHINGTON, DC, 20005-3096, US

(21) Appl. No.: 11/955,946

(22) Filed: Dec. 13, 2007

Related U.S. Application Data
(60) Provisional application No. 60/874,466, filed on Dec. 13, 2006.

(51) Int. Cl. G06Q 30/00; G06Q 90/00

(52) U.S. Cl. 705/1

(57) ABSTRACT

A computer-implemented system and method for evaluating watercraft, particularly from a remote location. The system includes an evaluation server that receives requests to evaluate a boat from clients. Upon receipt of an evaluation request, the evaluation server submits a request to the client to provide detailed information regarding the boat to be evaluated via a particular website. Once the client has submitted the requested information, the evaluation server notifies a marine surveyor of the report and requests that the surveyor provide comments and cite safety regulations relevant to the boat being inspected. Upon receipt of the surveyor's comments and citations, the evaluation server assembles all gathered information and provides a report to the client or a designated representative.

### RELATED APPLICATIONS

This application claims priority from U.S. Provisional Application No. 60/874,466, filed on Dec. 13, 2006, which is incorporated herein by reference.

### TECHNICAL FIELD

The disclosure relates generally to the fields of marine surveying, marine insurance underwriting, marine insurance claims handling and the like, and more specifically to a computerized system and method for remotely assessing the condition and/or value of a given watercraft.

### BACKGROUND

Marine insurance underwriters rely on marine surveys, such as inspections or examinations of subject boats to determine condition and value both prior to issuing a policy and periodically thereafter. Underwriters further rely on marine surveyors, usually acting as independent contractors, to provide such surveys when ordered. Resulting surveys are broad in scope, examining all aspects of a given boat's hull, rigging and fuel and electrical systems to name only a few areas of interest. The surveys are also very detailed, resulting in comprehensive reports that include photographs, comments, citations of appropriate code sections and assessments of condition and value of the subject boat at the time of inspection.

Many insurance underwriters rely on surveys to determine an “agreed value,” which is the amount the underwriting company and the owner of the boat have agreed that the boat is worth (current market value) and is usually the basis of determining what an insurance company will pay (less a deductible) in the event of a Constructive Total Loss (CTL). This figure and another, the approximate replacement value, are also factors in establishing the premium for the insurance coverage. While published guides to boat valuations exist, e.g., the NADA, BUC and ABOS guides, which are routinely updated to reflect market experience, individual boats are often extensively customized and are subject to wide variations in condition, equipage, etc., rendering valuations provided by such guides usable only as statistical bases for refining such methods as used by experts in establishing approximate fair market value. Further, the market for boats is regional. A boat located on the southeast coast or in tropical climates may be valued differently from an identical boat located in the Great Lakes, New England or other more moderate climates such as the Chesapeake Bay. Underwriters rely extensively on the expertise of the marine surveyor to determine the basis of the agreed value and other parameters of the policy offered to the client.

Complete surveys are generally ordered by underwriters when a boat risk is being considered for the first time and then, periodically, in accordance with the respective underwriter's timeline for review of its book of assumed business. It is the responsibility of the insured to provide the survey at the company's request and, usually, this survey is at the expense of the insured. The new survey becomes the basis for updating underwriting decisions, often resulting in an adjusted agreed value and/or requirements for maintenance and/or equipage as indicated in the survey report. Few alternative procedures exist for the purposes of adjusting the agreed value in the absence of a complete survey.

Marine surveyors may be qualified as certified and/or accredited by two primary professional organizations, the National Association of Marine Surveyors (NAMS certified/CMS) and the Society of Accredited Marine Surveyors (SAMS accredited/AMS). Each group maintains standards of qualification and ethical conduct of its members and each examines its members to determine technical competence and professional integrity. Members are permitted to publicly announce and promote their affiliation to potential clients, giving an additional measure for comparison of services. Other individuals, not affiliated with any certifying organization, are considered qualified by virtue of their earned reputations and their qualifications are recognized as equal to or surpassing those who have achieved formal certification and/or accreditation. Aside from peer recognition and performance oversight, there are no national or state regulations governing the activities of marine surveyors.

Regulation of the recreational boat production and boating activity is a duty, primarily, of the United States Coast Guard (USCG), formerly under the U.S. Department of Transportation but now a division of the Department of Homeland Security. The USCG maintains and publishes its regulations in the Code of Federal Regulations (CFR), which carries the force of law. The USCG code covers many aspects of the construction of boats and equipment and is applicable to manufacturers. Other Federal regulations (i.e., carriage requirements) apply to boat operators. The American Boat & Yacht Council (ABYC), based in Annapolis, Md., develops and publishes the voluntary consensus safety standards and practices, which extensively parallel, exceed and extend the applicable CFR. The National Fire Protection Association (NFPA) 302 (watercraft) and 303 (marinas and boatyards) are voluntary standards that complement the USCG and ABYC work products. The Society of Automotive Engineers (SAE) standards also cover limited marine issues, primarily as related to engines and mechanical systems. Underwriters' Laboratories (UL) also has standards for watercraft applications. The International Organization for Standardization is recognized as an emerging global resource, originating in the EU (European markets) for watercraft safety standards. ISO is the correct acronym for the organization. Because “International Organization for Standardization” would have different acronyms in different languages, ISO founders chose “ISO”, derived from the Greek isos, meaning “equal”.

Reports generated by marine surveyors are not subject to a uniform format, which often results in an unnecessary profusion of report formats, jargon and literary quality that sometimes requires increased effort on the part of the user to make decisions based on the information contained in the report. Further, there is a broad disparity in the adoption of and competence in using modern technological report preparation tools in the creation of reports.

To date, few alternative means exist for those with a current or future vested interest in a boat to quickly and efficiently obtain initial and interim assessments of condition and value of boats. What is acknowledged is the need for a resolution that combines currently accessible computer, Internet and communications technology and task specific technical expertise into a product that addresses the needs of all the stakeholders in the evaluation process: owners, underwriters and surveyors, insurance claim file managers and, in an extension of the concept, banks and other marine lenders, yacht brokers, prospective purchasers, boatyards and other service and watercraft storage facilities, attorneys, etc.

### SUMMARY

Accordingly, the disclosure relates to a system and method for remotely evaluating watercraft. A server system for evaluating watercraft comprises at least a user interface module for generating and displaying a plurality of data entry forms used to retrieve data related to the marine boat and a processing module for compiling the retrieved data to generate an evaluation report.

A computer-implemented method of remotely evaluating watercraft and preparing an evaluation report is provided, comprising at least the steps of: receiving a request to initiate an evaluation, receiving a description of the watercraft via a user interface designed to collect data, transmitting the received description to a marine surveyor, and compiling the received description and the received comments to create an evaluation report.

### BRIEF DESCRIPTION OF THE DRAWINGS

FIG. 1 depicts an overall system diagram of a marine boat evaluation system, in accordance with one embodiment.

FIG. 2 is a block diagram depicting a server for processing an evaluation request, in accordance with one embodiment.

FIG. 3 is a flow chart depicting an overall process for performing a watercraft evaluation, in accordance with one embodiment.

FIG. 4 depicts an initial entry form, in accordance with one embodiment.

FIG. 5 depicts a data entry form, in accordance with one embodiment.

FIG. 6 depicts an inspection form, in accordance with one embodiment.

FIG. 7 depicts a surveyor form, in accordance with one embodiment.

### DETAILED DESCRIPTION OF THE DISCLOSURE

The present disclosure is directed toward a system and method for evaluating marine boats, particularly from a remote location. As used herein, the term “watercraft” refers to any watercraft, boat, yacht, ship, or other marine vessel. The system includes an evaluation server that receives requests to evaluate a watercraft from clients. Upon receipt of an evaluation request, the evaluation server submits a request to the client to provide detailed information regarding the watercraft to be evaluated via a particular website. Once the client has submitted the requested information, the evaluation server notifies a marine surveyor of the report and requests that the surveyor provide comments and cite safety regulations relevant to the boat being inspected. Upon receipt of the surveyor's comments and citations, the evaluation server assembles all gathered information and provides a report to the client or a designated representative.

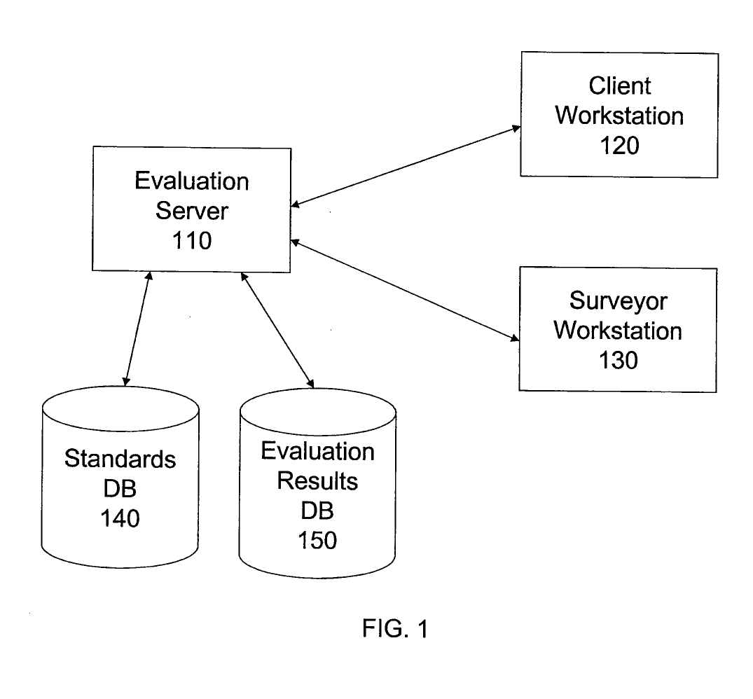

Referring to FIG. 1, an exemplary system 100 for evaluating a watercraft is illustrated. System 100 may comprise evaluation server 110, client workstation 120, surveyor workstation 130, standards database 140, and evaluation results database 150. Evaluation server 110 is communicatively coupled to each of the remaining system components, enabling the exchange of data.

Evaluation server 110 may be configured to host a website used to coordinate the evaluation of a watercraft upon the request of a client. Clients may include, for example, a boat owner or the owner's authorized agent, an insurance agent or underwriter, a financial lender, and/or any other party having a vested interest in the watercraft. According to one embodiment, evaluation server 110 operates in different modes to present different types of reports, depending on the type of client. For example, a boat/watercraft owner or his designated agent may purchase a report online (consumer version) to have a boat evaluated prior to selling the boat. A triage version may be provided for insurance underwriters or agents that prepares a truncated report to determine the severity of a given claim for damage prior to or in lieu of a physical onsite survey. The triage report may be used to determine, for example, whether the subject boat is a Constructive Total Loss (CTL), in which case no physical on-site inspection may be required, whether a physical on-site inspection should be immediately commissioned, or that no immediate action is needed. The triage version enables an insurance underwriter's claim department to determine where and how to deploy its limited resources, an especially advantageous strategy during periods of catastrophic loss experience, e.g., hurricanes. This leads to more efficient customer service and enables an underwriter to quickly settle claims that are obviously in the CTL category. An underwriter or lender may receive a report that includes an estimated value of the boat used in determining the risk level associated with financing. Other versions may also be provided for other user types.

The client submits a request to evaluation server 110 via client workstation 120. Client workstation 120 may be any electronic computing device capable of electronically transmitting and receiving data. For example, client workstation 120 may be a personal computer, a portable digital assistant (PDA), a mobile telephone having data capabilities, and/or other electronic computing devices. Surveyor workstation 130 enables a pre-certified surveyor to receive and review preliminary reports compiled by evaluation server 110. The surveyor may provide comments to supplement the preliminary report. Like client workstation 120, surveyor workstation 130 may include any electronic computing device capable of electronically transmitting and receiving data, such as, for example, a personal computer, a portable digital assistant (PDA), a mobile telephone having data capabilities, and/or other electronic computing devices.

As described above, a plurality of rules and standards are applied to watercraft surveying. For example, rules and regulations of the United States Coast Guard are maintained and published in the Code of Federal Regulations (CFR). Furthermore, the American Boat & Yacht Council (ABYC) develops and publishes various standards applicable to watercraft. Standards database 140 may be configured to store and maintain these rules and standards in a manner accessible by evaluation server 110. Evaluation results database 150 may be configured to archive all data collected and compiled in preparing an evaluation report.

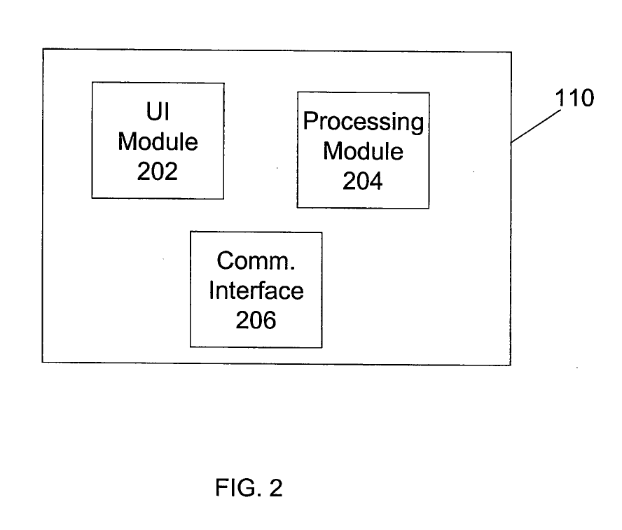

FIG. 2 depicts evaluation server 110 in greater detail. Evaluation server 110 may comprise a user interface module 202, processing module 204, and communications interface module 206. User interface module 202 may be configured to provide a plurality of forms enabling clients and surveyors to input necessary information for completing an evaluation. For example, forms may include an initial entry form wherein a client may be presented with options to initiate an evaluation request, complete an inspection in response to a request, or retrieve a report. Other forms may include a data entry for entering data describing the boat, a surveyor form wherein the surveyor may input comments and cite applicable rules, regulations, and standards, registration forms for registering surveyors and/or clients to use the evaluation server, and/or other forms.

Processing module 204 may be configured to execute one or more sequences of instructions necessary to complete an evaluation request. For example, processing module 204 may be configured to compile data received from clients and surveyors to complete an evaluation report. Processing module 204 may also be configured to update and maintain standards database 140 (depicted in FIG. 1). This may include, for example, automatically retrieving standards and rules from a third party source on a regularly scheduled basis, or manually entering and updating the standard and rules on a regularly scheduled basis.

Communications interface module 206 provides a communication channel between evaluation server 110 and surveyor workstation 120 and client workstation 130.

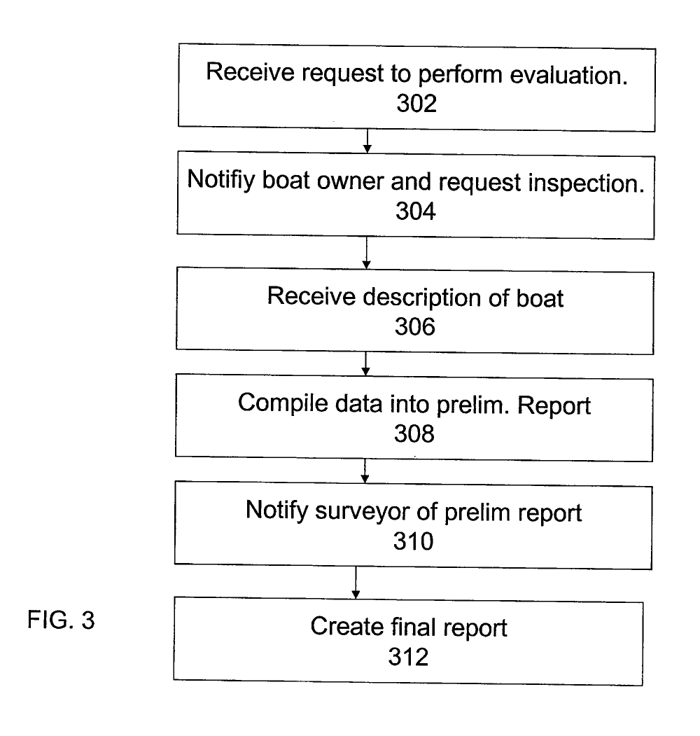

FIG. 3 depicts an overall process for remotely evaluating watercraft, in accordance with one embodiment. As depicted at 302, the process begins when a request is made to perform an evaluation of a watercraft. According to one embodiment, a request may be initiated directly by a boat owner or by the owner's authorized representation by visiting a designated website and purchasing a report. In other embodiments, a request may be initiated by an insurance underwriter or agent to report an insurance claim. In still other embodiments, an underwriter of lender may initiate a report as an aid in determining risk levels, which may include determining an interim condition that affects the agreed value of the boat.

Once the request has been initiated, notification may be sent to the boat owner or an authorized representative (if the request was not made by the boat owner or authorized representative), as depicted at 304. Notification may be provided, for example, by email, postal mail, facsimile, telephone, and/or other communications methods. The notification informs the boat owner that an inspection has been ordered. The owner may elect to complete the inspection or may appoint a representative to do so. The notification may include instructions directing the owner to visit a specific website in order to complete the inspection.

As depicted at 306, the owner visits the specified website and inputs the information required to complete an evaluation report. This may include, for example, submitting specific digital photographs or videos of the boat, equipment, and system therein via the website. Additionally, the owner may be requested to answer a series of questions regarding the boat, its systems, its operations, and/or other relevant questions. Complete descriptions of the photographs or videos requested and additional information about the questions being asked may be provided in help files associated with the system. Once the owner has provided all of the requested information, the owner acknowledges that the use of the system does not constitute a marine survey and submits the responses.

As depicted at 308, upon receipt of the owner's evaluation data, the data is compiled into a preliminary report and a marine surveyor is notified of the report and requested to review it. As described above, marine surveyors may be certified by one or more certifying organizations. In accordance with one embodiment, a plurality of marine surveyors are pre-screened and are registered with the system to review preliminary reports. Notification may be provided, for example, via email, facsimile, postal mail, or otherwise provided. The notification includes information, such as a uniform resource locator (URL) that links the surveyor directly to the appropriate report.

When the surveyor visits the provided URL, the surveyor is provided a copy of the preliminary report, as depicted at 310. The preliminary report includes the owner's responses as well as any digital photographs and/or videos that were submitted. The photographs and/or videos may be formatted such that they may be viewed by the surveyor but not altered. In addition to the preliminary report, the URL may also present a plurality of fields wherein the surveyor may provide comments and/or cite safety regulations and standards. According to one embodiment, the surveyor selects applicable regulations and standards from a provided menu. The citations are then incorporated into the final report. The surveyor may be asked to provide a valuation, as appropriate. Upon completing all provided questions, the surveyor electronically submits the form.

As depicted at 312, upon submission by the surveyor, the server assembles the information gathered at each stage of the process into a final report. The report may contain information about the subject boat, including the questions and answers, photographs (and/or videos) supplied by the owner, the citations made by the surveyor, the surveyor's comments, recommendations, and valuation, and/or other gathered information. A cover document may be prepared with a summary of the findings. The report may be converted into an industry standard format such as, for example, portable document format.

All information supplied by the parties involved may be stored in database tables maintained and periodically archived by an administrator. The final report may be provided to the initiator of the report, the boat owner, and/or other parties designated by the initiator. The report may be provided via email, facsimile, postal mail, and/or other delivery methods.

The processes described in connection with FIG. 3 may be implemented in hard-wired devices, firmware, or software running in a processor. Processing module 204 (FIG. 1) may be used for a software or firmware implementation. This process may be contained on a computer readable medium that may be read by the processing module. A computer readable medium may be any medium capable of carrying instructions to be performed by a microprocessor, including a CD disc, DVD disc, magnetic or optical disc, tape, silicon based removable or non-removable memory, wireline or wireless transmission signals.

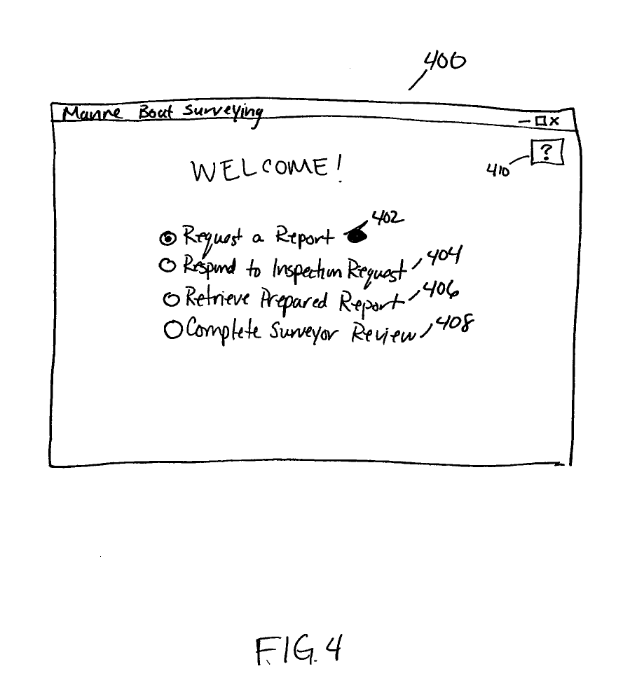

FIG. 4 is an exemplary initial entry form 400, in accordance with one embodiment. Initial entry form 400 provides a client with a plurality of processing options. For example, the client may elect to request a new report, as depicted at 402, respond to an inspection request, as depicted at 404, retrieve a report, as depicted at 406, or complete a surveyor review, as depicted at 408. Other options may be provided. As depicted in FIG. 4, a client may select the appropriate option by selecting a radio button associated with the particular option and selecting submit button 408. Other known electronic form selection options may be used including, for example, selecting a link associated with the desired option, choosing an option from a drop-down menu, typing the desired option in to a provided field, and/or any other form selection option.

Each form may include customized help files. For example, as depicted in FIG. 4, a help button 410 may be provided for launching customized help pages. The help pages may be tailored to the specific form and may provide options for searching the all help files. Additional support may be offered by direct contact with the server administrator, via email links provided for this purpose of via telephone during stated business hours.

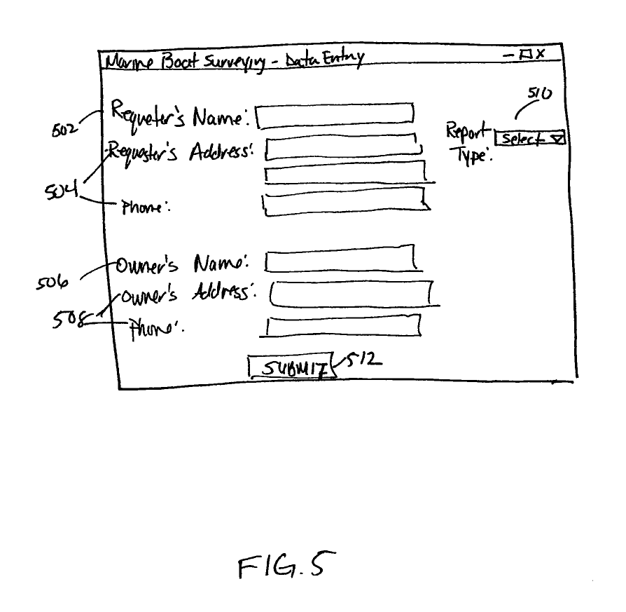

FIG. 5 is an exemplary data entry form 500, in accordance with one embodiment. A client may access form 500 by visiting initial entry form 400 and selecting the option to request a new report. Form 500 may include requester's name field 502, fields 504 for entering the requester's contact information (i.e., phone number, address, email address, fax number, etc.), boat owner's name field 506, and boat owner's contact information fields 508. Additionally, a report type field 510 may be provided. Report type field 510 may include options to select a consumer report, a triage report, a condition/valuation report, and/or other reports. Submit button 512 is provided to submit the entered information and begin the evaluation process. According to one embodiment, the claim receives a confirmation page confirming the request and providing a case number.

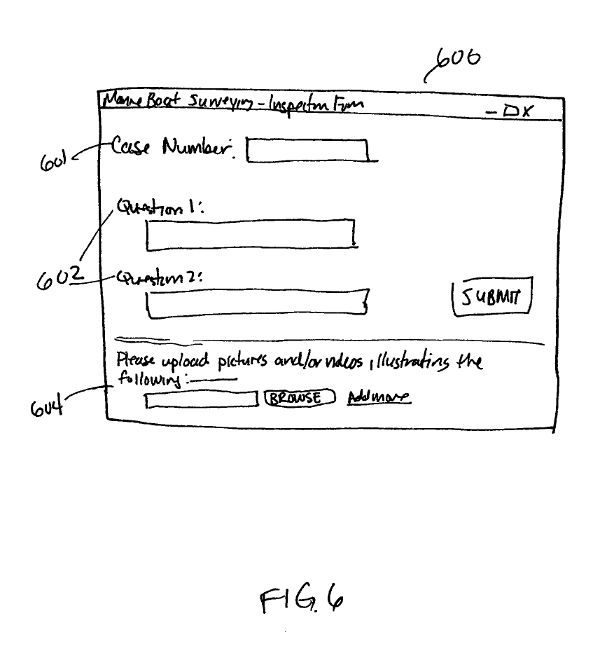

FIG. 6 depicts an exemplary inspection form 600, according to one embodiment. A client may access inspection form 600 by following a link provided in a notification message, or by selecting the option in initial entry form 400 to respond to an inspection request. If the client reaches form 600 by selecting the appropriate option from form 400, a field 601 may be provided for entering the case number associated with the inspection. Form 600 may include a plurality of fields 602 for answering questions and providing a description of the boat. Questions may include, for example, the type of boat, the age of the boat, any known problems associated with the boat, the size of the boat, and/or other questions. Upload field 604 may be provided to upload pictures and/or video clips of the boat and its systems. Other fields may be provided.

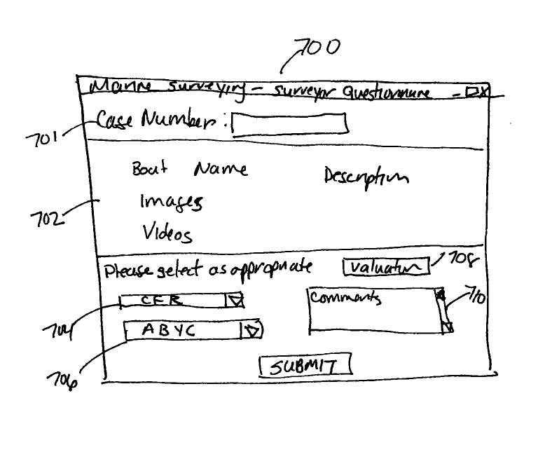

FIG. 7 depicts an exemplary surveyor form 700, according to one embodiment. A surveyor may access surveyor form 700 by following a link provided in a notification message, or by selecting the option in initial entry form 400 to respond to complete a surveyor review. If the client reaches form 700 by selecting the appropriate option from form 400, a field 701 may be provided for entering the case number associated with the report. Surveyor form 700 may include boat information section 702, which displays the information provided by the boat owner describing the boat. This includes the answers to the questions and the photographs/videos that were uploaded. A CFR citation field 704 may be provided enabling the surveyor to select one or more CFR provisions applicable to the boat. ABYC citation field 706 enables the surveyor to select one more ABYC standards. A valuation field 708 may be provided enabling the surveyor to provide an estimated boat value, if requested. Comments field 710 provides space for the surveyor to include any additional comments.

Multiple embodiments described above may be modified wherein a client initiating an evaluation request may elect to specify questions to be included, photographs to be requested, and surveyors to be employed in the review. According to some embodiments, the client may specify a graphical paradigm presenting the forms. While the forms described above reside on the evaluation server, the forms may reside on a client workstation.

While the system and methods described above are not intended as a complete replacement for physical inspection, they represent a significant savings in time and treasure of a traditional physical on-site survey, which, historically, has been the only way an owner or underwriter can gain a snapshot of the condition and/or value of a given boat. The final report may itself, in fact, recommend that a full survey be performed or the owner or underwriter may elect to commission one.

The previous description of the disclosed embodiments is provided to enable any person skilled in the art to make or use the present invention. While the systems and methods have been described above in relation to watercraft, it may also be used to inspect, examine and evaluate other goods and property such as but not limited to: recreational vehicles, airplanes, road vehicles and/or property and operations including but not limited to marinas and boatyards and other service facilities, docks, piers, buildings, equipment such as lifts (straddlelifts, forklifts, cranes), barges and dredges, etc., golf courses and their related facilities and equipment and other not named goods, property and operations as may be deemed suited to the application. Various modifications to these embodiments will be readily apparent to those skilled in the art and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A computer-implemented method of evaluating watercraft, comprising:
receiving, via a designated website, a request to evaluate a watercraft;
transmitting a request to a client to complete a preliminary evaluation report, the client being the owner of the watercraft or an authorized representative;
upon receipt of a completed preliminary inspection report, requesting a review of the report by a pre-certified watercraft surveyor; and
generating an evaluation report.

2. The method of claim 1, wherein transmitting a request to the client to complete a preliminary inspection report comprises:
providing instructions for accessing a designated website, the website providing a plurality of questions related to the condition of the watercraft.

3. The method of claim 1, wherein request for a preliminary inspection report is submitted via email.

4. The method of claim 1, wherein the request to evaluate includes an identification of the watercraft to be evaluated and contact information for the owner of the boat or an authorized representative.

5. The method of claim 1, wherein requesting review by a pre-certified watercraft surveyor comprises:
choosing a pre-certified surveyor; and
providing instructions to the chosen surveyor to access the preliminary inspection report via a designated website.

6. The method of claim 5, wherein the review by the surveyor comprises citations to rules applicable to the watercraft being evaluated.

7. A computer-implemented system for evaluating watercraft comprising:
an evaluation server for receiving and processing requests to evaluate a watercraft;
a standards database for storing and maintaining rules and standards related to the evaluation of watercraft; and
a results database for storing data collected and compiled in order to complete an evaluation report.

8. The computer-implemented system of claim 7, wherein the evaluation server comprises:
a user interface module for providing a plurality of forms for facilitating the creation of the evaluation report; and
a processing module for compiling data received from a plurality of sources used to evaluate the watercraft.

9. The computer-implemented system of claim 8, wherein the plurality of sources include the owner of the watercraft being evaluated and a certified watercraft surveyor.

10. The computer-implemented system of claim 8, wherein the plurality of forms include an initial entry form for choosing whether to request an evaluation report, respond to a request to complete a preliminary inspection report, complete a surveyor review, or retrieve a complete evaluation report.

11. The computer-implemented system of claim 8, wherein the plurality of forms includes a data entry form, the data entry form comprising:
a plurality of fields for entering contact information associated with a requester of an evaluation report;
a plurality of fields for entering contact information associated with the owner of the watercraft to be evaluated; and
a field for selecting a type of evaluation report to be prepared.

12. The computer-implemented system of claim 8, wherein the plurality of forms includes a preliminary inspection form comprising:
a field for identifying the marine boat for which the preliminary inspection is being performed;
a plurality of questions fields providing questions related to the watercraft being inspected; and
one or more fields for entering pictures or video images of the watercraft being evaluated.

13. The computer-implemented system of claim 8, wherein the plurality of forms includes a surveyor questionnaire comprising:
a field for identifying the watercraft for which the survey is being completed; and
a plurality of fields for selecting one or more rules or standards associated with the watercraft being evaluated.
